(19) United States
(12) Patent Application Publication
(10) Pub. No.: US 2026/0046377 A1
(43) Pub. Date: Feb. 12, 2026

(54) IMAGE DATA RETENTION ASSOCIATED WITH A COMPUTER VISION SYSTEM

(71) Applicant: Toshiba Global Commerce Solutions, Inc., Durham, NC (US)

(72) Inventors: Columbus L. Brown, II, Wake Forest, NC (US); David J. Steiner, Durham, NC (US); Shannon Love, Morrisville, NC (US); Kevin Corry, Ballwin, MO (US)

(73) Assignee: Toshiba Global Commerce Solutions, Inc., Durham, NC (US)

(21) Appl. No.: 18/797,130

(22) Filed: Aug. 7, 2024

(51) Int. Cl. H04N 7/18; G06V 20/52; G06V 20/62; G06V 40/16

(52) U.S. Cl. CPC H04N 7/181; G06V 20/52; G06V 20/625; G06V 40/16; G06V 2201/08; G06V 2201/10

(57) ABSTRACT

Systems and methods of performing image data retention associated with a computer vision system are described. In one exemplary embodiment, a method is performed by a network node operationally coupled to a set of optical sensor devices positioned about a retail space. Further, each optical sensor device has a field of view towards a certain region about the retail space and is operable to capture sequential images that correspond to the certain region. The method includes storing, in non-volatile memory, data that corresponds to the sequential images captured the optical sensor devices of a subject as that subject traverses about the retail space. The method also includes selecting a portion of the stored image data that corresponds to a physical view of the subject or a certain activity performed by the subject while about the retail space to retain in the non-volatile memory.

### BACKGROUND

Computer vision technology enables computers and systems to derive meaningful information from digital images, videos, and other visual inputs. The computers and systems can take actions or make recommendations based on that information. Computer vision is used in industries ranging from energy and utilities to manufacturing and automotive, with computer visions use continuing to grow.

### BRIEF DESCRIPTION OF THE DRAWINGS

The present disclosure will now be described more fully hereinafter with reference to the accompanying drawings, in which embodiments of the disclosure are shown. However, this disclosure should not be construed as limited to the embodiments set forth herein. Rather, these embodiments are provided so that this disclosure will be thorough and complete, and will fully convey the scope of the disclosure to those skilled in the art. Like numbers refer to like elements throughout.

FIG. 1 illustrates one embodiment of a system of performing image data retention in accordance with various aspects as described herein.

FIG. 2A illustrates one embodiment of a network node device in accordance with various aspects as described herein. FIG. 2B illustrates another embodiment of a network node device in accordance with various aspects as described herein. FIG. 2C illustrates another embodiment of a network node device in accordance with various aspects as described herein.

FIG. 3 illustrates another embodiment of network node device in accordance with various aspects as described herein.

FIG. 4A illustrates one embodiment of a method performed by a network node device of image data retention associated with a computer vision system in accordance with various aspects as described herein. FIG. 4B illustrates another embodiment of a method performed by a network node device of image data retention associated with a computer vision system in accordance with various aspects as described herein. FIG. 4C illustrates another embodiment of a method performed by a network node device of image data retention associated with a computer vision system in accordance with various aspects as described herein.

FIG. 5 illustrates other embodiments of a network node device in accordance with various aspects as described herein.

### DETAILED DESCRIPTION

For simplicity and illustrative purposes, the present disclosure is described by referring mainly to exemplary embodiments thereof. In the following description, numerous specific details are set forth to provide a thorough understanding of the present disclosure. However, it will be readily apparent to one of ordinary skill in the art that the present disclosure may be practiced without limitation to these specific details.

When a crime is committed in a store (e.g., shoplifting, theft), there is little information available to identify the crime or the subject (e.g., customer, vendor, store employee, cashier, manager, merchandiser, representative, sales associate, security guard, loss prevention specialist) of the crime. Low detailed images (e.g., blurry, dark, grainy) taken at obtuse angles relative to the subject may be available. More and more retail stores are installing higher resolution cameras that are deployed throughout the store such as to monitor self-checkout stations. However, the storage of the video data captured by these higher resolution cameras can become cost prohibitive especially when stored for an extended time period. This disclosure includes exemplary embodiments associated with cost-effectively retaining in storage video data captured by a computer vision system implemented in a retail store. Further, this disclosure includes exemplary embodiments associated with retaining video data captured by a computer vision system that corresponds to a clear image of subjects entering a retail store such as images of the front physical view (e.g., facial view, body view) of subjects, so that those retained images can be used for later identification of a certain subject. By doing so, the amount of retained video data such as from every high-resolution camera monitoring the retail space can be substantially reduced, resulting in lower cost.

In one exemplary embodiment, a system can be configured to capture images of each person in a retail store until the system has identified images that correspond to the physical view of a subject captured at different angles. The system can then select from those identified images certain images to retain in non-volatile memory such as those images that identify or measure the most physical features of a subject or that result in improved physical identification. Further, the system can be configured to use existing technology to track a subject through the store while identifying and selecting those images of the physical view of the subject that best represent that physical view. A physical view can include a visual representation of a subject that includes facial and/or body aspects. Further, a physical view can include an image or perspective that represents the physical presence of a subject, including a facial view and/or a body view. In addition, a physical view can include a holistic visual portrayal of a subject, highlighting facial characteristics and bodily form, providing a more comprehensive representation of the physical appearance of a subject. A facial view can include facial features such as eyes, nose, mouth, and expressions. A facial view can also include certain facial attributes such as eye color, eye shape, eyebrows, cheekbones, jawline, chin, skin tone, skin texture, hairline, facial hair, hair color, any distinguishing marks or characteristics of the face (e.g., dimples, expression lines, moles, piercings, scars, birthmarks, tattoos), or the like. A body view can include any of the full body structure such as posture, limbs, and physique. A body view can also include the arrangement and positioning of the body parts, clothing, accessories (e.g., jewelry, watch) and any other body attributes (e.g., scars, tattoos, birthmarks, moles, piercings). Further, a body view can include certain body characteristics such as height, body build, posture, weight, body proportions, muscle definition, limb length, hands, feet, body marks (e.g., scars, tattoos, birthmarks, moles, piercings), body fat distribution, gait, flexibility, physical condition, or the like.

In another exemplary embodiment, a similar system would use those cameras of the computer vision system that are positioned in the parking lot to identify a vehicle used by a subject and store in non-volatile memory those images of the vehicle's license plate that best represents the information displayed on that license plate.

In another exemplary embodiment, the image data saved to non-volatile memory by a computer vision system can be tailored for specific needs associated with the operation of a retail store. For instance, the initial image data stored to non-volatile memory could include a large amount of full motion video of a subject while facing the corresponding camera of the computer vision system or performing certain actions such as entering or exiting the store, passing though checkout, moving quickly through the parking lot such as running from retail store security, or the like. This large amount of full motion, high resolution video data of a subject would be removed from non-volatile memory such as after a certain time period (e.g., one day, one week) unless retail store personnel indicated that a problem (e.g., theft) occurred in the store. Other information about a subject (e.g., facial images, activity performed, vehicle license plate information) could be retained in non-volatile memory for a longer time period (e.g., one month, three months, six months, one year).

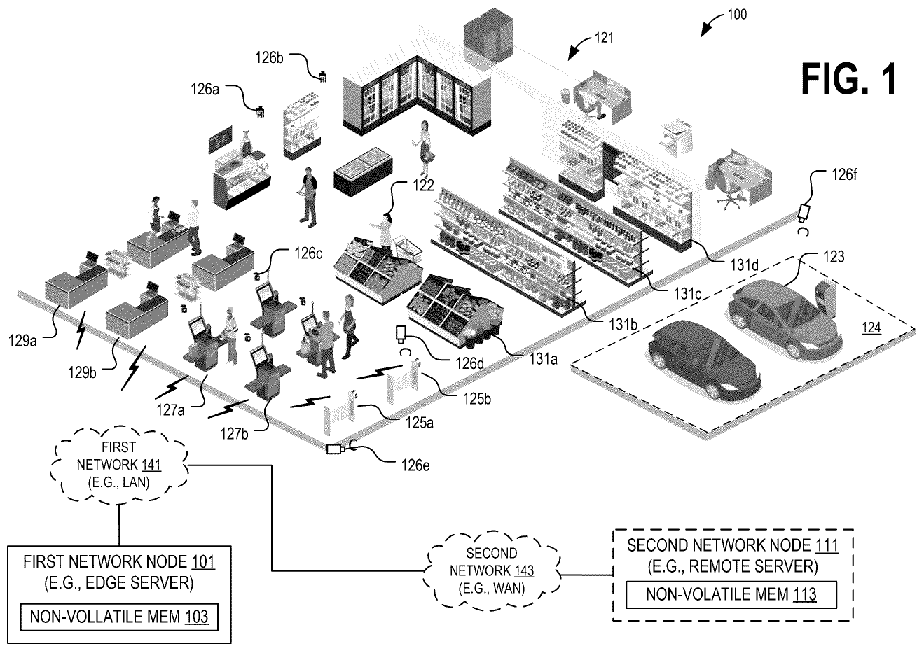

Furthermore, the exemplary embodiments described herein include improved techniques to perform image data retention associated with a computer vision system. For example, FIG. 1 illustrates one embodiment of a system 100 of performing image data retention in accordance with various aspect as described herein. In FIG. 1, the system 100 includes a first network node device 101 (e.g., edge server) operationally coupled over a first network 141 (e.g., LAN) to entry/exit gate terminals 125a,b, video camera devices 126a-f of a vision tracking system (not shown), self-checkout stations 127a-b, cashier-performed checkout stations 129a-b, shelves 131a-d having a set of retail items, the like, or any combination thereof. Further, the first network node 101 can be operationally coupled to a second network node 111 over a second networks 143 (e.g., WAN, Internet). The retail store 121 can also be associated with a parking lot 124. The retail store 121 can be a boutique store, a department store, a supermarket store, a convenience store, a warehouse store, a cashierless store, a frictionless store, the like, or any combination thereof. The first and second network node 101, 111 can include processing circuitry operable to execute instructions stored in volatile memory and non-volatile memory 103, 113 and to store data in the volatile memory 103, 113. Further, the first network node 101 can be operable to store data in the volatile memory 113 of the second network node 111 over the second network 143.

In FIG. 1, the first network node 101 can also be configured to improve the operational efficiency and customer experience in the retail store environment 121. The first network node 101 can be configured to process data locally within the retail store 121, reducing latency and improving response times for applications such as point of sale (POS) systems, inventory management, and customer relationship management (CRM) tools. Further, the first network node 101 can be configured to collect and analyze data from various sensors and devices deployed throughout the store, including IoT devices, entry/exit gate terminals 125a,b, video devices 126a-c of the vision tracking system, self-checkout stations 127a-b, cashier-performed checkout stations 129a-b, surveillance cameras, and the vision tracking system to enable real-time insights into customer behavior, foot traffic patterns, and inventory levels. The first network node 101 can also be configured to utilize digital signage, promotional displays, and interactive kiosks to engage customers such as delivering multimedia content locally, ensuring smooth playback and reducing dependence on external network bandwidth. In addition, the first network node 101 can be configured to process video feeds provided by the video devices 126a-c, security cameras and surveillance systems c to the vision tracking system, perform tasks such as facial recognition, license plate recognition and anomaly detection, and generate alerts for security breaches or suspicious activities in real-time. Additionally, the first network node 101 can be configured to track inventory movements in real-time, update inventory databases, and trigger alerts for low stock levels, enabling timely replenishment and reducing out-of-stock situations. The first network node 101 can also enable personalized customer experiences by analyzing historical data and current interactions such as recommending products based on past purchases or browsing behavior, enhancing cross-selling opportunities. The first network node 101 can also operate autonomously to ensure that essential functions such as POS transactions and security monitoring remain uninterrupted.

Each entry/exit gate terminal 125a,b can include an optical scanner device operable to scan or capture an image of an optical machine readable code (e.g., QR code, bar code) such as displayed on a display of a wireless device 101 (e.g., smartphone) of a customer to enable entry/exit by that customer to/from the retail store 121. The vision tracking system of the retail store 121 can include the video devices 126a-c strategically positioned throughout the retail store 121 to cover areas where customers may move in the store 121. Further, the vision tracking system can apply advanced computer vision algorithms to video captured by the video devices 126a-c to detect and track objects such as products and customers in real-time. Such algorithms may include facial recognition or other identification methods to recognize and track individual customers as they move through the store 121, product recognition algorithms to identify and track products to monitor inventory and customer selections, movement tracking algorithms to monitor the movement of customers and products within the store 121, including picking up items, placing them back, and purchasing decisions. The vision tracking system can also be operationally coupled to the first network node 101 to integrate with store inventory systems and payment systems to track product availability and customer purchases. In addition, the vision tracking system can analyze customer behavior, traffic patterns, popular products, and other data to improve store layout, product placement, and overall customer experience.

Each self-checkout station 127a-b can be configured to include a scanner device operable to scan a barcode on retail items or can be configured to enable manually entering retail item codes such as on a touchscreen display device. Each self-checkout station 127a-b can also include a bagging area where customers can place scanned items. Further, each self-checkout station 127a-b can verify that items have been scanned and placed correctly to prevent errors or theft. In addition, each self-checkout station 127a-b can accept various forms of payment, including credit/debit cards, mobile payment apps, and sometimes cash, can apply coupons or discounts directly at the self-checkout station, can print a receipt after completing the transaction, can apply security features such as weight sensors to detect unscanned items or unexpected changes in weight during bagging, can provide a user interface to guide customers through each step of the checkout process, or the like. Each cashier-performed checkout station 129a-b can be configured as a checkout lane manned by store personnel such as cashiers. Further, each checkout station 129a-b can be configured to enable customers to bring their items to the cashier, who scans each item using a barcode scanner or manually enters item codes into the system. Each checkout station 129a-b can also include a bagging area where, after scanning, the cashier can place the items into bags or containers for the customer. In addition, each checkout station 129a-b can also be configured to enable payment such as cash, credit/debit cards, and mobile payments and to present coupons or discounts, which the cashier can scan or enter into the system to apply to the transaction. In addition, each checkout station 129a-b can be configured to print a receipt for the customer, which includes details of the purchased items and the total amount paid. Cashiers can provide assistance to customers throughout the checkout process, including answering questions about products, handling returns or exchanges, and providing information on store policies. Cashiers can also be responsible for monitoring security, such as checking for age verification on restricted items (e.g., alcohol, tobacco) and ensuring that items have been properly scanned and paid for.

The non-volatile memory 103, 113 can be configured to retain stored information even after power is removed from that memory 103, 113. The non-volatile memory 103, 113 can include flash memory (e.g., NOR flash, NAND flash), ferroelectric RAM (FeRAM or FRAM), magnetoresistive RAM (MRAM), phase-change memory (PCM or PRAM), resistive RAM (ReRAM or RRAM), nano-RAM (NRAM), hard disk drive, disk storage, optical disk, floppy disk, magnetic tape, the like, or any combination thereof. The sequential image data stored in the non-volatile memory 103, 113 can be removed so that it is no longer accessible or retrievable. In one example, the data can be erased, returning the non-volatile memory to its original state where it can store new data. In another example, the sequential image data stored in the non-volatile memory 103, 113 can be overwritten with new data.

In operation, the first network node device 101 (e.g., edge server) can obtain data that corresponds to the sequential images (e.g., video) captured by at least one of the set of optical sensor devices 126a-f (e.g., cameras) of the subject 122 (e.g., customer) as that subject 122 traverses about the retail space 121. For example, the first network node device 101 can receive, from the at least one of the set of optical sensor devices 126a-f such as over the first network 141 (e.g., LAN), the data that corresponds to the sequential images captured by the corresponding optical sensor devices 126a-f of the subject 122 as that subject traverses about the retail space 121. In another example, each optical sensor device 126a-f can be operable to also obtain and send image meta data based on the sequential images captured by the corresponding optical sensor device. The image meta data can refer to supplementary data embedded within the sequential image data that provides information about the image itself such as facial information and body information of the subjects displayed in the corresponding image. The facial information can include meta data about the detected faces in the image, such as the number of faces, the coordinates of facial landmarks (e.g., eyes, nose, mouth), expressions, and other facial attributes (e.g., eye color, eye shape, eyebrows, cheekbones, jawline, chin, skin tone, skin texture, hairline, facial hair, hair color, any distinguishing marks or characteristics of the face) and body attributes (e.g., posture, limbs, physique, body parts arrangement/positioning, clothing, accessories, scars, tattoos, birthmarks, moles, piercings). The facial and body information can also include facial and body recognition data to enable identifying, classifying or verifying the identity of the subjects in the image. The body information can include meta data about the posture and position of a subject's body in the image, body landmarks (e.g., shoulders, elbows, hands, hips, knees, and feet), body orientation, gestures, and other physical attributes (e.g., height, weight, clothing, and visible accessories). Further, the sequential image data can include the image meta data. The first network node device 101 can determine the image meta data associated with the physical information of the subject 122 based on the sequential image data of the subject 122. The first network node device 101 can store in the non-volatile memory 103, 113 the sequential image data that corresponds to the subject as that subject traverses about the retail space. In one example, the first network node device stores the sequential image data in the non-volatile memory 103 of the first network node 101. In another example, the first network node device stores, through communication with the second network node device 111 over the network 143 (e.g., WAN, Internet), the sequential image data in the non-volatile memory 113 of the second network node device 111.

Furthermore, the first network node device 101 can identify the stored image data that corresponds to the physical view of the subject based on the image meta data associated with the physical information of the subject. The first network node device 101 can then select a portion of the identified image data that corresponds to those images that enable physical identification of the subject 122. In one example, the first network node device 101 can select the portion of the identified image data that corresponds to those images that enable the physical identification of the subject 122 based on the most physical features of that subject 122. In another example, the first network node device 101 can select the portion of the identified image data of the subject that represents a certain number (e.g., 1, 10, 100, 1000) of images of the subject 122. In another example, the first network node device 101 can select the portion of the identified image data of the subject that represents a certain percentage (e.g., 0.1%, 1%, 10%) of the images of that subject 122. In yet another example, the first network node device 101 can select the portion of the identified image data of the subject 122 as being those images having certain types of views (e.g., front, rear, left side, right side) of the subject 122. In yet another example, the first network node device 101 can select the portion of the identified image data of the subject 122 as being those images that include another subject that is identified as having entered the retail space 121 with the subject 122. Further, the selected images of the subject 122 or the other subject can be used to train an artificial intelligence circuit to enable the artificial intelligence circuit to identify the subject 122 or the other subject with a certain confidence level (e.g., 75%, 90%, 95%). The first network node device 101 can retain in the non-volatile memory 103, 113 the selected portion. In addition, the first network node device 101 can indicate that the identified image data that does not correspond to the selection portion can be removed from the non-volatile memory 103, 113. The first network node device 101 can then enable removal of the indicated image data from the non-volatile memory 103, 113. In one example, the first network node device 101 can erase or overwrite the indicated image data stored in the non-volatile memory 103. In another example, the first network node device 101 can send, to the second network node device 111 over the network 143, an indication to remove the indicated image data. In response, the second network node device 111 can remove the indicated image data from the non-volatile memory 113. For instance, the second network node device 111 can erase or overwrite the indicated image data stored in the non-volatile memory 113.

In another exemplary embodiment, the first network node device 101 can identify the stored sequential image data that corresponds to a certain activity performed by the subject 122 while about the retail space 121 based on the image meta data associated with the physical information of the subject 122. The certain activity can include any activity that can be performed by the subject 122 in the retail store 121 such as the subject 122 exiting his/her vehicle 123 while in a parking lot 124 of the retail store 121, the subject 122 entering the retail store 121 such as through an entry gate terminal 125b, the subject 122 obtaining a retail item off a shelf 131a-d of the retail store 121, the subject 122 performing a self-checkout transaction at a self-checkout station 127a-b, the subject 122 performing a cashier-assisted transaction at a checkout station 129a-b, the subject 122 exiting the retail store 121 such as through an exit gate terminal 125a, the like, or any combination thereof. In addition, the certain activity can be associated with a certain crime that can be committed about the retail store 121 such as shoplifting, employee theft, fraud, robbery, burglary, vandalism, assault, identity theft, return fraud, price tag switching, gift card fraud, coupon fraud, credit card skimming, check fraud, organized retail fraud, vehicle theft, vehicle break-in, panhandling, drug dealing, trespassing, public intoxication, solicitation, harassment, hit and run, parking lot scam (e.g., fake vehicle accidents, claims of vehicle damage), the like, or any combination thereof. The first network node device 101 can select a portion of the identified image data that corresponds to the certain activity performed by the subject 122. Further, the first network node device 101 can retain in the non-volatile memory 103, 113 the selected portion. The first network node device 101 can also indicate that the identified stored sequential image data that does not correspond to the selected portion can be removed (e.g., erased, overwritten) from the non-volatile memory 103, 113. The first network node device 101 can then enable removal of the indicated stored sequential image data from the non-volatile memory 103, 113.

In another exemplary embodiment, the first network node device 101 can identify store sequential image data that corresponds to the subject 122 and a parking lot 124 about the retail space 121. Further, the first network node device 101 can detect a vehicle 123 (e.g., car, motorcycle, motorhome, truck, delivery vehicle) that corresponds to the subject 122 based on the identified stored sequential image data. The first network node device 101 can detect a license plate object of the vehicle 123 that corresponds to the subject 122 based on the identified stored sequential image data. In addition, the first network node device 101 can select a portion of the identified stored sequential image data that corresponds to the license plate object associated with the subject 122. The first network node device 101 can retain in the non-volatile memory 103, 113 the selected portion that corresponds to the license plage object associated with the subject 122. Further, the first network node device 101 can indicate that the identified data that does not correspond to the selected portion of that identified data can be removed from the non-volatile memory 103, 113. The first network node device 101 can then enable the removal of the indicated data from the non-volatile memory 103, 113.

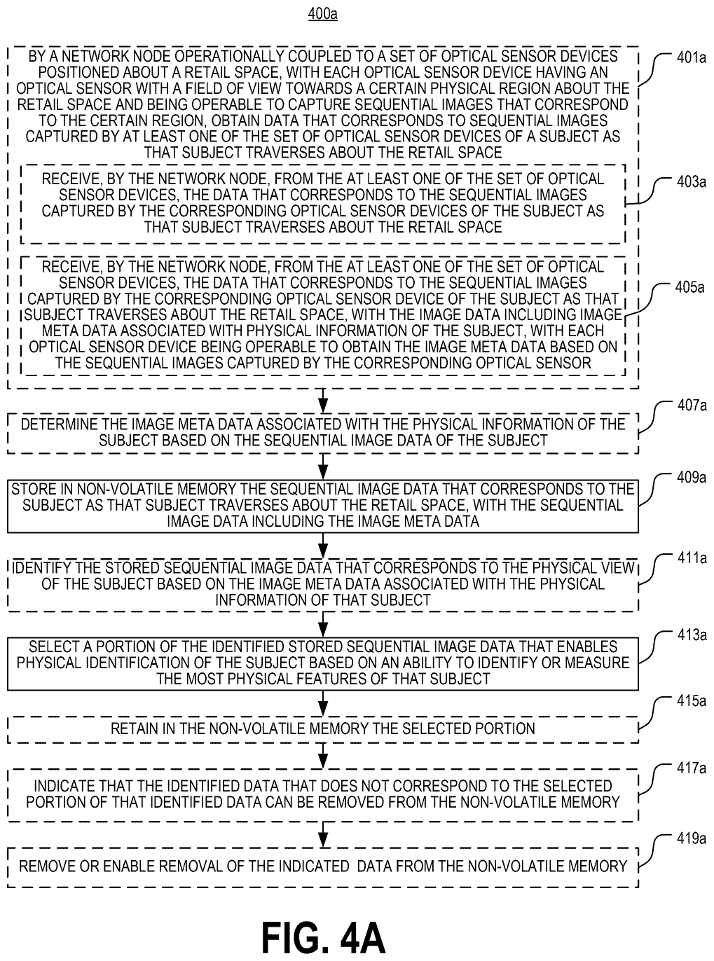

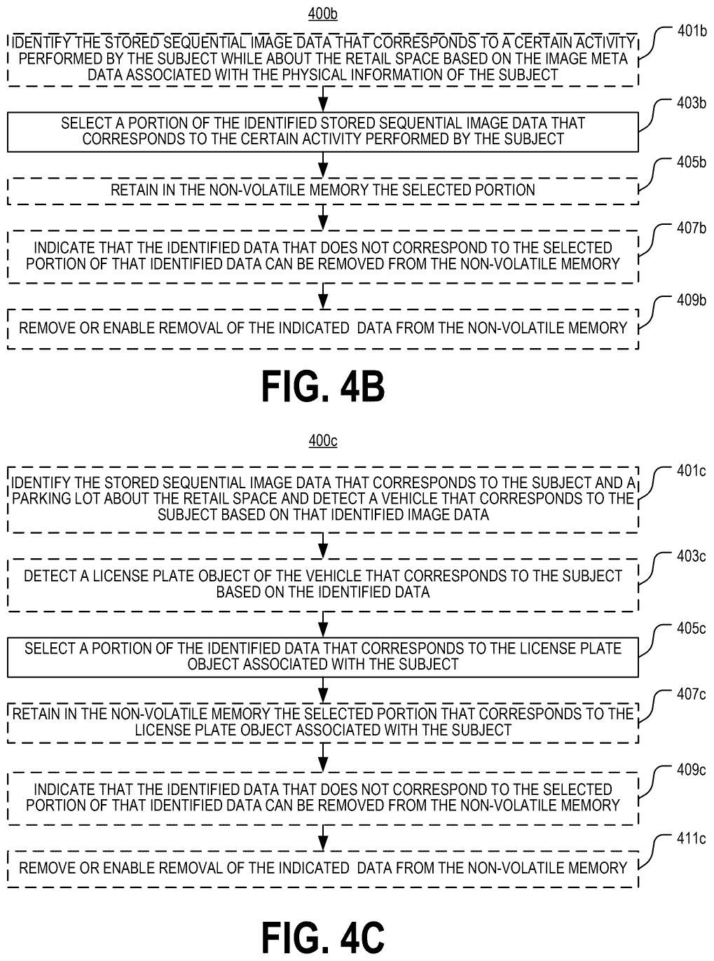

In another exemplary embodiment, all or a portion of the functions performed by the first network node 101 can, alternatively or additionally, be performed by the second network node 111. For instance, the first network node 101 can send, to the second network node 111 over the second network 143, the sequential image data that corresponds to the subject as that subject traverses about the retail space. The second network node 111 can receive that sequential image data and can then perform any of the method steps described by blocks 411a, 413a, 415a, 417a, 419a in FIG. 4A as well as any of the method steps described by FIG. 4B and FIG. 4C.

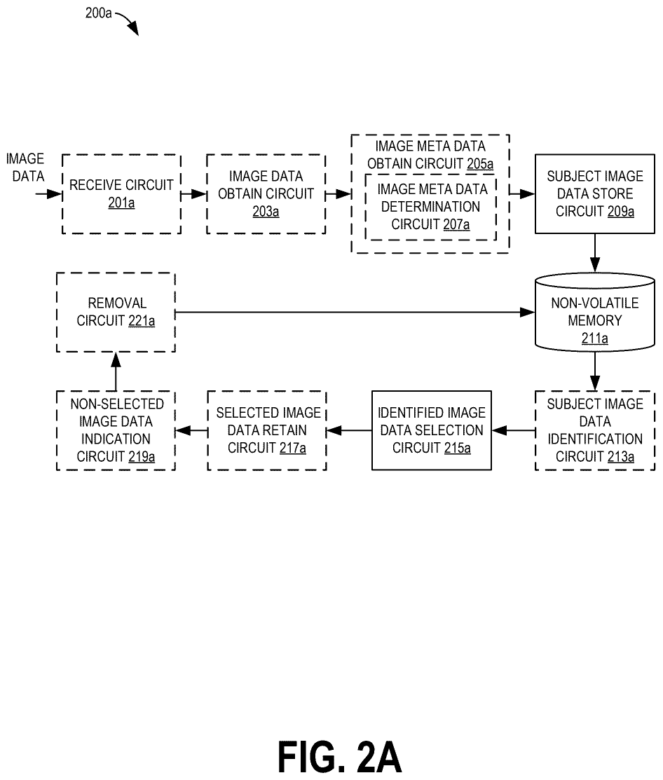

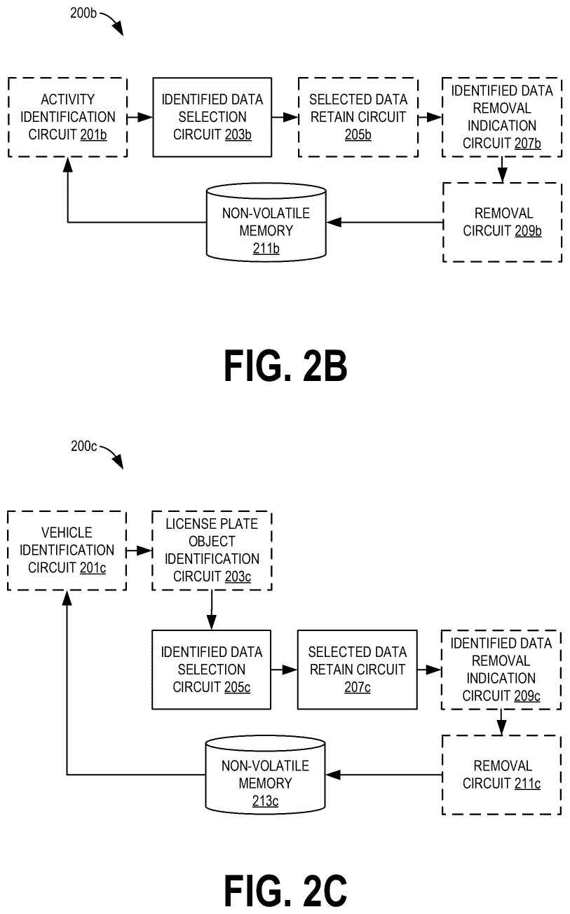

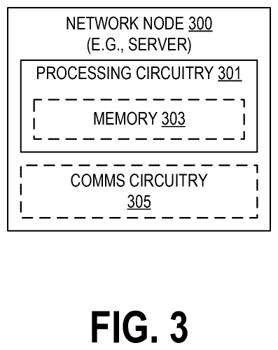

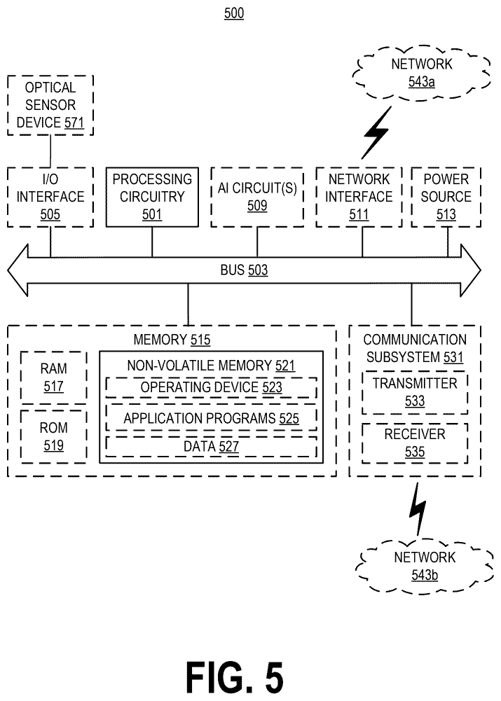

FIG. 2A illustrates another embodiment of a network node device 200a in accordance with various aspects as described herein. In FIG. 2A, the device 200a implements various functional means, units, or modules (e.g., via the processing circuitry 301 in FIG. 3, via the processing circuitry 501 in FIG. 5, via software code, or the like), or circuits. In one embodiment, these functional means, units, modules, or circuits (e.g., for implementing the method(s) described herein) may include for instance: a receive circuit 201a operable to receive information; a sequential image data obtain circuit 203a operable to obtain sequential image data such as from a set of optical sensor devices; an image meta data obtain circuit 205a operable to obtain image meta data associated with physical information of a subject based on obtained sequential image data; an image meta data determination circuit 207a operable to determine image meta data associated with physical information of a subject based on obtained sequential image data; a subject image data store circuit 209a operable to store in non-volatile memory 211a sequential image data that corresponds to a subject based on image meta data associated with the physical information of that subject; a subject image data identification circuit 213a operable to identify the stored sequential image data that corresponds to the physical view of the subject based on the image meta data associated with the physical information of that subject; an identified image data selection circuit 215a operable to select a portion of the identified stored sequential image data that enables physical identification of a subject based on an ability to identify or measure the most physical features of that subject; a selected image data retain circuit 217a operable to retain in the non-volatile memory 211a that selected portion; non-selected image data indication circuit 219a operable to indicate that the identified data that does not correspond to the selection portion of that identified data can be removed from the non-volatile memory 211a; and/or a removal circuit 221a operable to remove or enable removal of the indicated data from the non-volatile memory 211a.

FIG. 2B illustrates another embodiment of a network node device 200b in accordance with various aspects as described herein. In FIG. 2B, the device 200b implements various functional means, units, or modules (e.g., via the processing circuitry 301 in FIG. 3, via the processing circuitry 501 in FIG. 5, via software code, or the like), or circuits. In one embodiment, these functional means, units, modules, or circuits (e.g., for implementing the method(s) described herein) may include for instance: an activity identification circuit 201b operable to identify stored sequential image data that corresponds to a certain activity performed by a subject while about a retail space based on the image meta data associated with the physical information of the subject; an identified data selection circuit 203b operable to select a portion of the identified stored sequential image data that corresponds to the certain activity performed by the subject; a selected data retain circuit 205b operable to retain in the non-volatile memory 211b the selected portion; an identified data removal indication circuit 207b operable to indicate that the identified data that does not correspond to the selected portion of that identified data can be removed from the non-volatile memory 211b; and/or a removal circuit 209b operable to remove or enable the removal of the indicated data from the non-volatile memory 211b.

FIG. 2C illustrates another embodiment of a network node device 200c in accordance with various aspects as described herein. In FIG. 2C, the device 200c implements various functional means, units, or modules (e.g., via the processing circuitry 301 in FIG. 3, via the processing circuitry 501 in FIG. 5, via software code, or the like), or circuits. In one embodiment, these functional means, units, modules, or circuits (e.g., for implementing the method(s) described herein) may include for instance: a vehicle identification circuit 201c operable to identify stored sequential image data that corresponds to a subject and a parking lot about a retail space and detect a vehicle that corresponds to the subject based on that identified image data; a license plate object identification circuit 203c operable to detect a license plate object of the vehicle that corresponds to the subject based on the identified data; an identified data selection circuit 205c operable to select a portion of the identified data that corresponds to the license plate object associated with the subject; a selected data retain circuit 207c operable to retain in the non-volatile memory 213c the selected portion that corresponds to the license plate object associated with the subject; an identified data removal indication circuit 209c operable to indicate that the identified data that does not correspond to the selected portion of that identified data can be removed from the non-volatile memory 213c; and/or a removal circuit 211c operable to remove or enable removal of the indicated data from the non-volatile memory 213c.

FIG. 3 illustrates another embodiment of a network node device 300 in accordance with various aspects as described herein. As shown, the device 300 includes processing circuitry 301 and communication circuitry 311. The communication circuitry 305 is configured to transmit and/or receive information to and/or from one or more other nodes (e.g., via any communication technology). The processing circuitry 301 is configured to perform processing described above, such as by executing instructions stored in memory 303. The processing circuitry 301 in this regard may implement certain functional means, units, or modules.

FIG. 4A illustrates one embodiment of a method 400a performed by a network node device of image data retention associated with a computer vision system in accordance with various aspects as described herein. In FIG. 4A, the method 400a may start, for instance, at block 401a where it can include obtaining data that corresponds to sequential images captured by at least one of the set of optical sensor devices of a subject as that subject traverses about the retail space. At block 403a, the method 400a can include receiving, by the network node, from the at least one of the set of optical sensor devices, the data that corresponds to the sequential images captured by the corresponding optical sensor devices of the subject as that subject traverses about the retail space. At block 405a, the method 400a may include receiving, by the network node, from the at least one of the set of optical sensor devices, the data that corresponds to the sequential images captured by the corresponding optical sensor devices of the subject as that subject traverses about the retail space, with the image data including image meta data associated with physical information of the subject. At block 407a, the method 400a can include determining the image meta data associated with the physical information of the subject based on the sequential image data of the subject. At block 409a, the method 400a includes storing in non-volatile memory the sequential image data that corresponds to the subject as that subject traverses about the retail space, with the sequential image data including the image meta data. At block 411a, the method 400a can include identifying the stored sequential image data that corresponds to the physical view of the subject based on the image meta data associated with the physical information of that subject. At block 413a, the method 400a includes selecting a portion of the identified stored sequential image data that enables physical identification of the subject based on an ability to identify or measure the most physical features of that subject. At block 415a, the method 400a can include retaining in the non-volatile memory the selected portion. At block 417a, the method 400a can include indicating that the identified data that does not correspond to the selected portion of that identified data can be removed from the non-volatile memory. At block 419a, the method 400a can include removing or enabling removal of the indicated data from the non-volatile memory.

FIG. 4B illustrates another embodiment of a method 400b performed by a network node device of image data retention associated with a computer vision system in accordance with various aspects as described herein. In FIG. 4B, the method 400b may start, for instance, at block 401b where it can include identifying the stored sequential image data that corresponds to a certain activity performed by the subject while about the retail space based on the image meta data associated with the physical information of the subject. At block 403b, the method 400b includes selecting a portion of the identified image data that corresponds to the certain activity performed by the subject. At block 405b, the method 400b can include retaining in the non-volatile memory the selected portion. At block 407b, the method 400b can include indicating that the identified data that does not correspond to the selection portion of that identified data can be removed from the non-volatile memory. At block 409b, the method 400b can include removing or enabling removal of the indicated data from the non-volatile memory.

FIG. 4C illustrates another embodiment of a method 400c performed by a network node device of image data retention associated with a computer vision system in accordance with various aspects as described herein. In FIG. 4C, the method 400c may start, for instance, at block 401c where it can include identifying the stored sequential image data that corresponds to the subject and a parking lot about the retail space and detecting a vehicle that corresponds to the subject based on that identified image data. At block 403c, the method 400c can include detecting a license plate object of the vehicle that corresponds to the subject based on the identified data. At block 405c, the method 400c includes selecting a portion of the identified data that corresponds to the license plate object associated with the subject. At block 407c, the method 400c can include retaining in the non-volatile memory the selected portion that corresponds to the license plate object associated with the subject. At block 409c, the method 400c can include indicating that the identified data that does not correspond to the selected portion of that identified data can be removed from the non-volatile memory. At block 411c, the method 400c can include removing or enabling removal of the indicated data from the non-volatile memory.

FIG. 5 illustrates another embodiment of a network node device 500 in accordance with various aspects as described herein. In FIG. 5, device 500 includes processing circuitry 501 that is operatively coupled to input/output interface 505, artificial intelligence (AI) circuit 509, network connection interface 511, memory 515 including random access memory (RAM) 517, read-only memory (ROM) 519, and non-volatile memory 521 or the like, communication subsystem 531, power source 513, and/or any other component, or any combination thereof.

The input/output interface 505 may be configured to provide a communication interface to an input device, output device, or input and output device. The device 500 may be configured to use an output device 561 via input/output interface 505. An output device 561 may use the same type of interface port as an input device. For example, a USB port may be used to provide input to and output from the device 500. The output device 561 may be a speaker, a sound card, a video card, a display, a monitor, a printer, an actuator, an emitter, a smartcard, another output device, or any combination thereof. The device 500 may be configured to use an input device via input/output interface 505 to allow a user to capture information into the device 500. The input device may include a touch-sensitive or presence-sensitive display, one or more optical sensor devices 571 (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical or image sensor, an infrared sensor, a proximity sensor, another like sensor, or any combination thereof.

In FIG. 5, non-volatile memory 521 may include operating system 523, application program 525, data 527, resolution data 529, the like, or any combination thereof. In other embodiments, non-volatile memory 521 may include other similar types of information. Certain devices may utilize all of the components shown in FIG. 5, or only a subset of the components. The level of integration between the components may vary from one device to another device. Further, certain devices may contain multiple instances of a component, such as multiple processors, memories, artificial intelligence circuits (e.g., neural networks), network connection interfaces, transceivers, etc.

In FIG. 5, processing circuitry 501 may be configured to process computer instructions and data. Processing circuitry 501 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 501 may include two central processing units (CPUs). Data may be information in a form suitable for use by a computer.

In FIG. 5, the AI circuit 509 may be configured to learn to perform tasks by considering examples such as performing object detection of certain objects in an image. In one example, a first AI circuit is configured to perform object detection or identification, in an image, of subjects, faces of subjects, vehicles, license plates on vehicles, or the like. Further, a second AI circuit is configured to perform detection of an activity of a subject. In FIG. 5, the network connection interface 511 may be configured to provide a communication interface to network 543a. The network 543a may encompass wired and/or wireless networks such as a local-area network (LAN), a wide-area network (WAN), a computer network, a wireless network, a telecommunications network, another like network or any combination thereof. For example, network 543a may comprise a Wi-Fi network. The network connection interface 511 may be configured to include a receiver and a transmitter interface used to communicate with one or more other devices over a communication network according to one or more communication protocols, such as Ethernet, TCP/IP, SONET, ATM, or the like. The network connection interface 511 may implement receiver and transmitter functionality appropriate to the communication network links (e.g., optical, electrical, and the like). The transmitter and receiver functions may share circuit components, software or firmware, or alternatively may be implemented separately.

The RAM 517 may be configured to interface via a bus 503 to the processing circuitry 501 to provide storage or caching of data or computer instructions during the execution of software programs such as the operating system, application programs, and device drivers. The ROM 519 may be configured to provide computer instructions or data to processing circuitry 501. For example, the ROM 519 may be configured to store invariant low-level system code or data for basic system functions such as basic input and output (I/O), startup, or reception of keystrokes from a keyboard that are stored in a non-volatile memory. The non-volatile memory 521 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, the non-volatile memory 521 may be configured to include an operating system 523, an application program 525 such as web browser, web application, user interface, browser data manager as described herein, a widget or gadget engine, or another application, and a data file 527. The non-volatile memory 521 may store, for use by the device 500, any of a variety of various operating systems or combinations of operating systems.

The non-volatile memory 521 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. The non-volatile memory 521 may allow the device 500a-b to access computer-executable instructions, application programs or the like, stored on transitory or non-transitory memory media, to off-load data, or to upload data. An article of manufacture, such as one utilizing a communication system may be tangibly embodied in the non-volatile memory 521, which may comprise a device readable medium.

The processing circuitry 501 may be configured to communicate with network 543b using the communication subsystem 531. The network 543a and the network 543b may be the same network or networks or different network or networks. The communication subsystem 531 may be configured to include one or more transceivers used to communicate with the network 543b. For example, the communication subsystem 531 may be configured to include one or more transceivers used to communicate with one or more remote transceivers of another device capable of wireless communication according to one or more communication protocols, such as IEEE 802.11, CDMA, WCDMA, GSM, LTE, UTRAN, WiMax, or the like. Each transceiver may include transmitter 533 and/or receiver 535 to implement transmitter or receiver functionality, respectively, appropriate to the RAN links (e.g., frequency allocations and the like). Further, transmitter 533 and receiver 535 of each transceiver may share circuit components, software, or firmware, or alternatively may be implemented separately.

In FIG. 5, the communication functions of the communication subsystem 531 may include data communication, voice communication, multimedia communication, short-range communications such as Bluetooth, near-field communication, location-based communication such as the use of the global positioning system (GPS) to determine a location, another like communication function, or any combination thereof. For example, the communication subsystem 531 may include cellular communication, Wi-Fi communication, Bluetooth communication, and GPS communication. The network 543b may encompass wired and/or wireless networks such as a local-area network (LAN), a wide-area network (WAN), a computer network, a wireless network, a telecommunications network, another like network or any combination thereof. For example, the network 543b may be a cellular network, a Wi-Fi network, and/or a near-field network. The power source 513 may be configured to provide alternating current (AC) or direct current (DC) power to components of the device 500a-b.

The features, benefits and/or functions described herein may be implemented in one of the components of the device 500 or partitioned across multiple components of the device 500. Further, the features, benefits, and/or functions described herein may be implemented in any combination of hardware, software, or firmware. In one example, communication subsystem 531 may be configured to include any of the components described herein. Further, the processing circuitry 501 may be configured to communicate with any of such components over the bus 503. In another example, any of such components may be represented by program instructions stored in memory that when executed by the processing circuitry 501 perform the corresponding functions described herein. In another example, the functionality of any of such components may be partitioned between the processing circuitry 501 and the communication subsystem 531. In another example, the non-computationally intensive functions of any of such components may be implemented in software or firmware and the computationally intensive functions may be implemented in hardware.

Those skilled in the art will also appreciate that embodiments herein further include corresponding computer programs.

A computer program comprises instructions which, when executed on at least one processor of an apparatus, cause the apparatus to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of an apparatus, cause the apparatus to perform as described above.

Embodiments further include a computer program product comprising program code portions for performing the steps of any of the embodiments herein when the computer program product is executed by a computing device. This computer program product may be stored on a computer readable recording medium.

Additional embodiments will now be described. At least some of these embodiments may be described as applicable in certain contexts for illustrative purposes, but the embodiments are similarly applicable in other contexts not explicitly described.

In one exemplary embodiment, a method is performed by a network node operationally coupled to a set of optical sensor devices positioned about a retail space. Further, each optical sensor device includes an optical sensor with a field of view towards a certain region about the retail space and is operable to capture sequential images that correspond to the certain region. The method includes storing, in non-volatile memory, data that corresponds to the sequential images captured by the optical sensor of at least one of the set of optical sensor devices of a subject as that subject traverses about the retail space. The method further includes selecting only a portion of the stored image data that corresponds to a physical view of the subject or a certain activity performed by the subject while about the retail space so that the selected portion can be retained in the non-volatile memory and the stored sequential image data that does not correspond to the selected portion can be removed from the non-volatile memory.

In another exemplary embodiment, the method further includes receiving, by the network node, from the at least one of the set of optical sensor devices, data that corresponds to the sequential images captured by the corresponding optical sensor of the subject as that subject traverses about the retail space.

In another exemplary embodiment, the method further includes determining image meta data associated with the physical information of the subject based on the image data of the subject.

In another exemplary embodiment, the method further includes receiving, by the network node, from at least one of the set of optical sensor devices, data that corresponds to the sequential images captured by the corresponding optical sensor of the subject as that subject traverses about the retail space. In addition, the image data includes image meta data associated with physical information of the subject. Each optical sensor device is operable to obtain the image meta data based on the sequential images captured by the corresponding optical sensor.

In another exemplary embodiment, the method further includes storing in the non-volatile memory the image data that corresponds to the subject as that subject traverses about the retail space, with the image data including image meta data associated with physical information of the subject.

In another exemplary embodiment, the method further includes selecting a portion of the stored sequential image data that is identified as corresponding to a physical view of the subject or a certain activity performed by the subject while about the retail space based on the image meta data associated with the physical information of the subject.

In another exemplary embodiment, the method further includes identifying the stored image data of the subject that corresponds to the physical view of the subject or a certain activity performed by the subject while about the retail space based on the image meta data associated with the physical information of the subject.

In another exemplary embodiment, the method further includes selecting a portion of the identified stored image data of the physical view of the subject; indicating that the identified image data of the physical view of the subject that does not correspond to the selected portion can be removed from the non-volatile memory; and/or removing the indicated stored image data from the non-volatile memory.

In another exemplary embodiment, the method further includes selecting a portion of the identified stored image data that corresponds to the certain activity performed by the subject while about the retail space; indicating that the identified image data that corresponds to the certain activity performed by the subject while about the retail space that does not correspond to the selected portion can be removed from the non-volatile memory; and/or removing the indicated stored image data from the non-volatile memory.

In another exemplary embodiment, the method further includes identifying the stored image data that corresponds to the subject and a parking lot about the retail space, with the optical sensor of at least one of the set of optical sensor devices being configured with a viewing angle towards the parking lot; detecting a motor vehicle that corresponds to the subject based on the identified image data; detecting a license plate object of the motor vehicle that corresponds to the subject based on the obtained sequential image data; selecting a portion of the identified image data that corresponds to the license plate object associated with the subject; retaining in the non-volatile memory the selected portion that corresponds to the license plate object associated with the subject; and/or indicating to be removed from the non-volatile memory the stored sequential image data that does not correspond to that identified portion.

In another exemplary embodiment, the certain activity includes a first activity that corresponds to a retail item being obtained by the subject while about the retail space and a second activity that corresponds to the subject exiting the retail space without completing a sales transaction for that retail item.

In one exemplary embodiment, a network node is operationally coupled to a set of optical sensor devices positioned about a retail space. Each optical sensor device includes an optical sensor with a field of view towards a certain region about the retail space and is operable to capture sequential images that correspond to the certain region. The network node is operable to store in non-volatile memory sequential image data that corresponds to the sequential images captured by the set of optical sensor devices. In addition, the network node further includes a processor and a memory, with the memory containing instructions executable by the processor whereby the processor is configured to store, in non-volatile memory, data that corresponds to the sequential images captured by the optical sensor of at least one of the set of optical sensor devices of a subject as that subject traverses about the retail space; and select a portion of the stored image data that corresponds to a physical view of the subject or a certain activity performed by the subject while about the retail space so that the selected portion can be retained in the non-volatile memory and the stored sequential image data that does not correspond to the selected portion can be removed from the non-volatile memory.

In one exemplary embodiment, a system includes a non-volatile memory, a set of optical sensor devices, and a network node. The set of optical sensor devices is positioned about a retail space, with each optical sensor device having an optical sensor with a field of view towards a certain region about the retail space and being operable to capture sequential images that correspond to the certain region. The network node is operationally coupled to the non-volatile memory and the set of optical sensor devices and is operable to store, in the non-volatile memory, data that corresponds to the sequential images captured by the optical sensor of at least one of the set of optical sensor devices of a subject as that subject traverses about the retail space; and select a portion of the stored image data that corresponds to a physical view of the subject or a certain activity performed by the subject while about the retail space so that the selected portion can be retained in the non-volatile memory and the stored sequential image data that does not correspond to the selected portion can be removed from the non-volatile memory.

The previous detailed description is merely illustrative in nature and is not intended to limit the present disclosure, or the application and uses of the present disclosure. Furthermore, there is no intention to be bound by any expressed or implied theory presented in the preceding field of use, background, summary, or detailed description. The present disclosure provides various examples, embodiments and the like, which may be described herein in terms of functional or logical block elements. The various aspects described herein are presented as methods, devices (or apparatus), systems, or articles of manufacture that may include a number of components, elements, members, modules, nodes, peripherals, or the like. Further, these methods, devices, systems, or articles of manufacture may include or not include additional components, elements, members, modules, nodes, peripherals, or the like.

Furthermore, the various aspects described herein may be implemented using standard programming or engineering techniques to produce software, firmware, hardware (e.g., circuits), or any combination thereof to control a computing device to implement the disclosed subject matter. It will be appreciated that some embodiments may be comprised of one or more generic or specialized processors such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the methods, devices and systems described herein. Alternatively, some or all functions could be implemented by a state machine that has no stored program instructions, or in one or more application specific integrated circuits (ASICs), in which each function or some combinations of certain of the functions are implemented as custom logic circuits. Of course, a combination of the two approaches may be used. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The term “article of manufacture” as used herein is intended to encompass a computer program accessible from any computing device, carrier, or media. For example, a computer-readable medium may include: a magnetic storage device such as a hard disk, a floppy disk or a magnetic strip; an optical disk such as a compact disk (CD) or digital versatile disk (DVD); a smart card; and a flash memory device such as a card, stick or key drive. Additionally, it should be appreciated that a carrier wave may be employed to carry computer-readable electronic data including those used in transmitting and receiving electronic data such as electronic mail (e-mail) or in accessing a computer network such as the Internet or a local area network (LAN). Of course, a person of ordinary skill in the art will recognize many modifications may be made to this configuration without departing from the scope or spirit of the subject matter of this disclosure.

Throughout the specification and the embodiments, the following terms take at least the meanings explicitly associated herein, unless the context clearly dictates otherwise. Relational terms such as “first” and “second,” and the like may be used solely to distinguish one entity or action from another entity or action without necessarily requiring or implying any actual such relationship or order between such entities or actions. The term “or” is intended to mean an inclusive “or” unless specified otherwise or clear from the context to be directed to an exclusive form. Further, the terms “a,” “an,” and “the” are intended to mean one or more unless specified otherwise or clear from the context to be directed to a singular form. The term “include” and its various forms are intended to mean including but not limited to. References to “one embodiment,” “an embodiment,” “example embodiment,” “various embodiments,” and other like terms indicate that the embodiments of the disclosed technology so described may include a particular function, feature, structure, or characteristic, but not every embodiment necessarily includes the particular function, feature, structure, or characteristic. Further, repeated use of the phrase “in one embodiment” does not necessarily refer to the same embodiment, although it may. The terms “substantially,” “essentially,” “approximately,” “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. A device or structure that is “configured” in a certain way is configured in at least that way, but may also be configured in ways that are not listed.

What is claimed is:

1. A method, comprising:
by a network node operationally coupled to a set of optical sensor devices positioned about a retail space, with each optical sensor device having an optical sensor with a field of view towards a certain region about the retail space and being operable to capture sequential images that correspond to the certain region,
storing, in non-volatile memory, data that corresponds to the sequential images captured by the optical sensor of at least one of the set of optical sensor devices of a subject as that subject traverses about the retail space; and
selecting a portion of the stored image data that corresponds to a physical view of the subject or a certain activity performed by the subject while about the retail space so that the selected portion can be retained in the non-volatile memory and the stored sequential image data that does not correspond to the selected portion can be removed from the non-volatile memory.

2. The method of claim 1, further comprising:
receiving, by the network node, from the at least one of the set of optical sensor devices, the data that corresponds to the sequential images captured by the corresponding optical sensor of the subject as that subject traverses about the retail space.

3. The method of claim 2, further comprising:
determining image meta data associated with the physical information of the subject based on the image data of the subject.

4. The method of claim 1, further comprising:
receiving, by the network node, from at least one of the set of optical sensor devices, data that corresponds to the sequential images captured by the corresponding optical sensor of the subject as that subject traverses about the retail space, wherein the image data includes image meta data associated with physical information of the subject, with each optical sensor device being operable to obtain the image meta data based on the sequential images captured by the corresponding optical sensor.

5. The method of claim 1, further comprising:
storing in the non-volatile memory the image data that corresponds to the subject as that subject traverses about the retail space, with the image data including image meta data associated with physical information of the subject.

6. The method of claim 1, further comprising:
selecting a portion of the stored sequential image data that is identified as corresponding to a physical view of the subject or a certain activity performed by the subject while about the retail space based on the image meta data associated with the physical information of the subject.

7. The method of claim 6, further comprising:
identifying the stored image data of the subject that corresponds to the physical view of the subject or a certain activity performed by the subject while about the retail space based on the image meta data associated with the physical information of the subject.

8. The method of claim 7, further comprising:
selecting a portion of the identified stored image data of the physical view of the subject;
indicating that the identified image data of the physical view of the subject that does not correspond to the selected portion can be removed from the non-volatile memory; and
removing or enabling removal of the indicated stored image data from the non-volatile memory.

9. The method of claim 7, further comprising:
selecting a portion of the identified stored image data that corresponds to the certain activity performed by the subject while about the retail space;
indicating that the identified image data that corresponds to the certain activity performed by the subject while about the retail space that does not correspond to the selected portion can be removed from the non-volatile memory; and
removing or enabling removal of the indicated stored image data from the non-volatile memory.

10. The method of claim 1, further comprising:
identifying the stored image data that corresponds to the subject and a parking lot about the retail space, with the optical sensor of at least one of the set of optical sensor devices being configured with a viewing angle towards the parking lot;
detecting a motor vehicle that corresponds to the subject based on the identified image data;
detecting a license plate object of the motor vehicle that corresponds to the subject based on the obtained sequential image data;
selecting a portion of the identified image data that corresponds to the license plate object associated with the subject;
retaining in the non-volatile memory the selected portion that corresponds to the license plate object associated with the subject; and
indicating to be removed from the non-volatile memory the stored sequential image data that does not correspond to that identified portion.

11. The method of claim 1, wherein the certain activity includes a first activity that corresponds to a retail item being obtained by the subject while about the retail space and a second activity that corresponds to the subject exiting the retail space without completing a sales transaction for that retail item.

12. A network node, comprising:
with the network node being operationally coupled to a set of optical sensor devices positioned about a retail space, with each optical sensor device having an optical sensor with a field of view towards a certain region about the retail space and being operable to capture sequential images that correspond to the certain region, the network node being operable to store in non-volatile memory sequential image data that corresponds to the sequential images captured by the set of optical sensor devices; and
wherein the network node further comprises a processor and a memory, the memory containing instructions executable by the processor whereby the processor is configured to:
store, in non-volatile memory, data that corresponds to the sequential images captured by the optical sensor of at least one of the set of optical sensor devices of a subject as that subject traverses about the retail space; and
select a portion of the stored image data that corresponds to a physical view of the subject or a certain activity performed by the subject while about the retail space so that the selected portion can be retained in the non-volatile memory and the stored sequential image data that does not correspond to the selected portion can be removed from the non-volatile memory.

13. The device of claim 12, wherein the memory contains instructions executable by the processor whereby the processor is further configured to:
receive, from the at least one of the set of optical sensor devices, data that corresponds to the sequential images captured by the corresponding optical sensor of the subject as that subject traverses about the retail space; and
determine image meta data associated with the physical information of the subject based on the image data of the subject.

14. The device of claim 12, wherein the memory contains instructions executable by the processor whereby the processor is further configured to:
receive, by the network node, from at least one of the set of optical sensor devices, data that corresponds to the sequential images captured by the corresponding optical sensor of the subject as that subject traverses about the retail space, wherein the image data includes image meta data associated with physical information of the subject, with each optical sensor device being operable to obtain the image meta data based on the sequential images captured by the corresponding optical sensor.

15. The device of claim 12, wherein the memory contains instructions executable by the processor whereby the processor is further configured to:
store in the non-volatile memory the image data that corresponds to the subject as that subject traverses about the retail space, with the image data including image meta data associated with physical information of the subject.

16. The device of claim 12, wherein the memory contains instructions executable by the processor whereby the processor is further configured to:
select a portion of the stored sequential image data that is identified as corresponding to a physical view of the subject or a certain activity performed by the subject while about the retail space based on the image meta data associated with the physical information of the subject.

17. The device of claim 12, wherein the memory contains instructions executable by the processor whereby the processor is further configured to:
identify the stored image data of the subject that corresponds to the physical view of the subject based on the image meta data associated with the physical information of the subject;
select a portion of the identified stored image data of the physical view of the subject;
indicate that the identified image data of the physical view of the subject that does not correspond to the selected portion can be removed from the non-volatile memory; and
remove or enable removal of the indicated stored image data from the non-volatile memory.

18. The device of claim 12, wherein the memory contains instructions executable by the processor whereby the processor is further configured to:
identify the stored image data of a certain activity performed by the subject while about the retail space based on the image meta data associated with the physical information of the subject;
select a portion of the identified stored image data that corresponds to the certain activity performed by the subject while about the retail space;
indicate that the identified image data that corresponds to the certain activity performed by the subject while about the retail space that does not correspond to the selected portion can be removed from the non-volatile memory; and
remove or enable removal of the indicated stored image data from the non-volatile memory.

19. The device of claim 12, wherein the memory contains instructions executable by the processor whereby the processor is further configured to:
identify the stored image data that corresponds to the subject and a parking lot about the retail space, with the optical sensor of at least one of the set of optical sensor devices being configured with a viewing angle towards the parking lot;
detect a motor vehicle that corresponds to the subject based on the identified image data;
detect a license plate object of the motor vehicle that corresponds to the subject based on the obtained sequential image data;
select a portion of the identified image data that corresponds to the license plate object associated with the subject;
retain in the non-volatile memory the selected portion that corresponds to the license plate object associated with the subject; and
indicate to be removed from the non-volatile memory the stored sequential image data that does not correspond to that identified portion.

20. A system, comprising:
a non-volatile memory operable to store information;
a set of optical sensor devices positioned about a retail space, with each optical sensor device having an optical sensor with a field of view towards a certain region about the retail space and being operable to capture sequential images that correspond to the certain region; and
a network node operationally coupled to the non-volatile memory and the set of optical sensor devices and operable to:
store, in the non-volatile memory, data that corresponds to the sequential images captured by the optical sensor of at least one of the set of optical sensor devices of a subject as that subject traverses about the retail space; and
select a portion of the stored image data that corresponds to a physical view of the subject or a certain activity performed by the subject while about the retail space so that the selected portion can be retained in the non-volatile memory and the stored sequential image data that does not correspond to the selected portion can be removed from the non-volatile memory.
